(19) United States
(12) Patent Application Publication
(10) Pub. No.: US 2026/0280647 A1
(43) Pub. Date: Sep. 17, 2026

(54) Enhanced Mobility Operations for Network Power Saving Modes

(71) Applicant: Apple Inc., Cupertino, CA (US)

(72) Inventors: Jie CUI, San Jose, CA (US); Dan WU, Beijing (CN); Dawei ZHANG, Saratoga, CA (US); Qiming LI, Beijing (CN); Rolando E BETTANCOURT ORTEGA, Munich (DE); Yang TANG, San Jose, CA (US)

(21) Appl. No.: 19/471,438

(22) PCT Filed: Apr. 4, 2023
(86) PCT No.: PCT/CN2023/086248

§ 371 Date: Oct. 1, 2025

(51) Int. Cl. H04B 7/06; H04L 5/00; H04W 24/10; H04W 76/28

(52) U.S. Cl. CPC H04B 7/0626; H04L 5/0048; H04W 24/10; H04W 76/28

(57) ABSTRACT

A user equipment (UE) is configured to receive a target neighbor cell (TNC) configuration from a network, the TNC configuration comprising a discontinuous transmission (DTX) configuration and a channel state information reference signal (CSI-RS) configuration, wherein the DTX configuration comprises a DTX cycle periodicity and wherein the CSI-RS comprises a CSI-RS periodicity, determine a physical layer (PHY) sampling interval based on at least the DTX configuration or the CSI-RS configuration and measure CSI-RS transmitted by the TNC during the PHY sampling interval

### TECHNICAL FIELD

The present disclosure generally relates to wireless communication, and in particular, to enhanced mobility operations for network power saving modes.

### BACKGROUND

Network energy saving (NES) and discontinuous transmission (DTX) are modes of operation for New Radio (NR) which reduces signaling and power draw. These operating modes typically involve a base station (e.g., a next generation node B (gNB)) muting certain transmissions such as Channel State Information Reference Signals (CSI-RS). User equipment (UE) may use the CSI-RS for mobility operations. Thus, various areas of CSI-RS operations need to be defined in mobility (e.g., handover) scenarios in relation to the two power saving modes for both UEs and the network.

### SUMMARY

Some exemplary embodiments are related to a method performed by a user equipment (UE). The method includes receiving a target neighbor cell (TNC) configuration from a network, the TNC configuration comprising a discontinuous transmission (DTX) configuration and a channel state information reference signal (CSI-RS) configuration, wherein the DTX configuration comprises a DTX cycle periodicity and wherein the CSI-RS comprises a CSI-RS periodicity, determining a physical layer (PHY) sampling interval based on at least the DTX configuration or the CSI-RS configuration and measuring CSI-RS transmitted by the TNC during the PHY sampling interval.

Other exemplary embodiments are related to a method performed by a serving cell. The method includes determining a target neighbor cell (TNC) for a user equipment (UE) is operating in a network energy saving (NES) mode and configuring the UE to perform synchronization signal block (SSB)-based mobility measurements based on the TNC operating in the NES mode.

Still further exemplary embodiments are related to a method performed by a user equipment (UE). The method includes determining whether a target neighbor cell (TNC) for the UE is operating in a network energy saving (NES) mode and receiving a mobility configuration from a network indicating the UE is to perform channel state information reference signal (CSI-RS) mobility measurements on the TNC.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an information element diagram according to various exemplary embodiments.

FIG. 5 shows a method diagram for UE measurement behavior for mobility measurements without measurement gap (MG) according to various exemplary embodiments.

FIG. 6 shows a method diagram for UE measurement behavior for mobility measurements with a measurement gap (MG) according to various exemplary embodiments.

FIG. 7 shows a method diagram illustrating mobility operations when the target neighbor cell is in NES mode according to various exemplary embodiments.

### DETAILED DESCRIPTION

The exemplary embodiments may be further understood with reference to the following description and the related appended drawings, wherein like elements are provided with the same reference numerals. The exemplary embodiments relate to improvements to mobility operations for NES and DTX.

The exemplary embodiments are described with regard to a UE. However, reference to a UE is merely provided for illustrative purposes. The exemplary embodiments may be utilized with any electronic component that may establish a connection to an accessory device and is configured with the hardware, software, and/or firmware to exchange information and data with accessory devices. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network.

Mobility is a core tenet of any cellular network. CSI-RS is a reference signal used in the Downlink (DL) direction in 5G NR. CSI-RS is used for channel sounding and for a UE to measure the characteristics of a radio channel. The DL channel quality is measured by a UE using these reference signals and reported back in the Uplink (UL) direction to a gNB through channel quality indictor (CQI) reports. CSI-RS are used by UEs and gNBs to determine when a UE should perform a handover operation.

DTX and NES are modes of operation of a gNB, both of which offer potential energy savings to the UE and the network. DTX and NES may be operated simultaneously. During mobility, it is possible that a UE may not be receiving during correct time intervals because of differences in DTX configurations. For example, a neighboring cell (e.g., non-serving) may have DTX enabled, while a serving cell may have DTX disabled. The UE must have some means of recognizing that the neighbor cell has DTX enabled because the UE will waste power monitoring for CSI-RS during times when the neighbor cell is not transmitting CSI-RS. In a second example, both the serving cell and neighbor cell may have DTX configured. In a third example, the serving cell may configure a measurement gap for the UE during CSI-RS measurements (e.g., inter-frequency measurement); in such a scenario the UE must consider how to handle both a measurement gap (MG) and the DTX window.

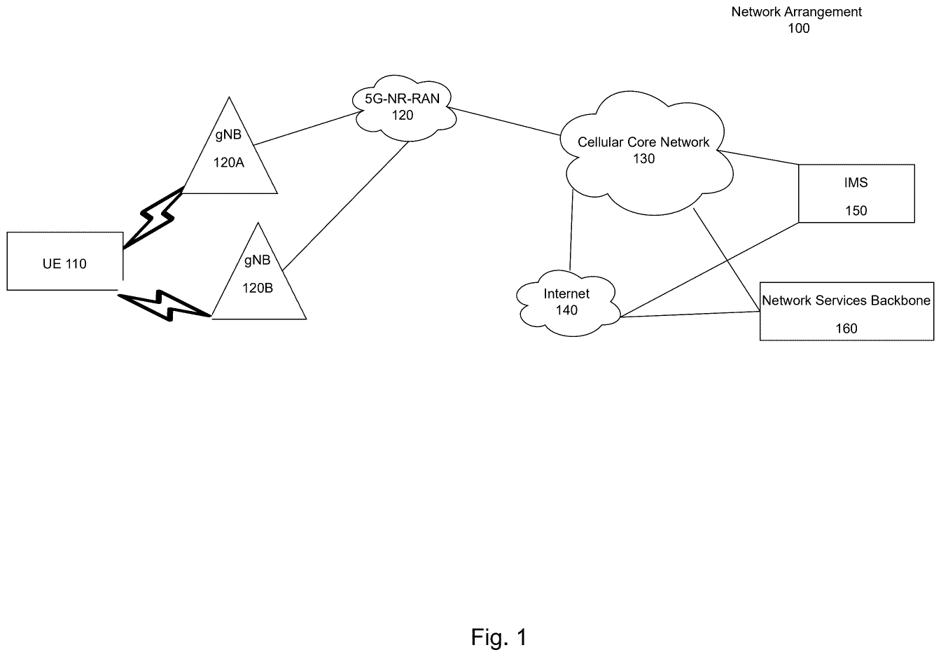

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of one UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e. g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A). There may also be one or more neighboring cells with which the UE may communicate with prior to a handover operation. One additional neighbor cell is shown in FIG. 1 with gNB 120B, but one of skill in the art will recognize that a UE may have more than one neighbor cells available for handover.

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

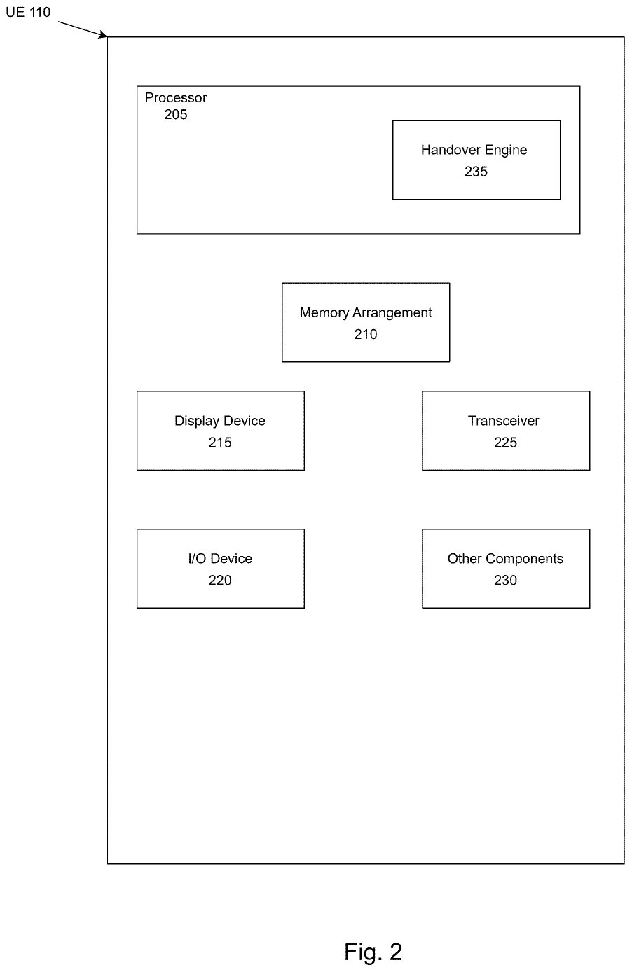

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a handover engine 235 for performing operations related to enhanced handover operations and logic for DTX and NES. ****

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

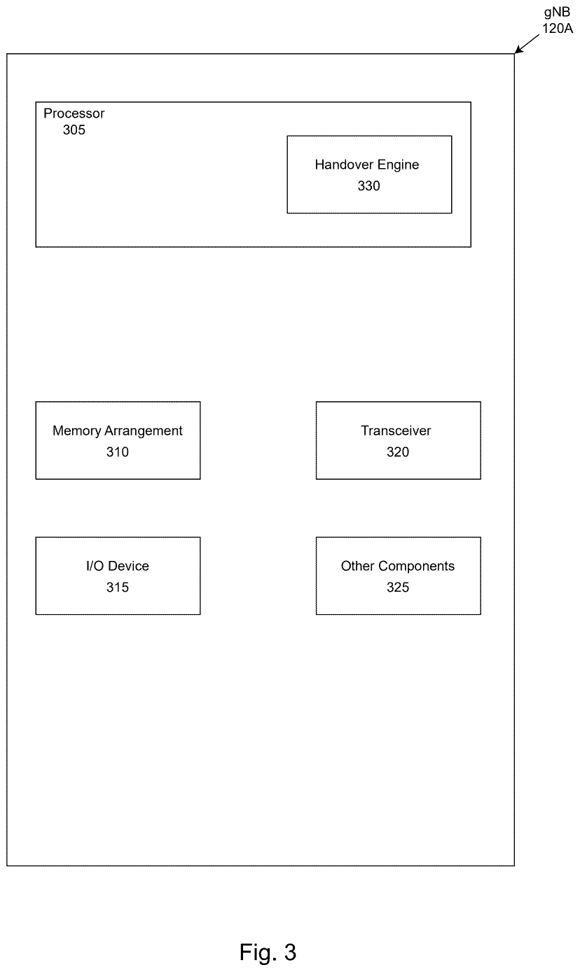

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a handover engine 330 for performing operations related to enhanced handover operations and logic for DTX and NES. ***

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

In a first aspect of the exemplary embodiments, a serving gNB will provide a neighbor cell list with CSI-RS measurement information to the UE. This CSI-RS measurement information includes information that may account for the DTX and/or NES modes of the gNBs. This information is provided to the UE in configuration information. Those skilled in the art will understand that when a UE is connected to a serving cell, the UE will receive configuration information for neighbor cells (e.g., neighbor cells to which the UE may be handed over by the serving cell). The configuration information may be provided to the UE using information elements (IEs).

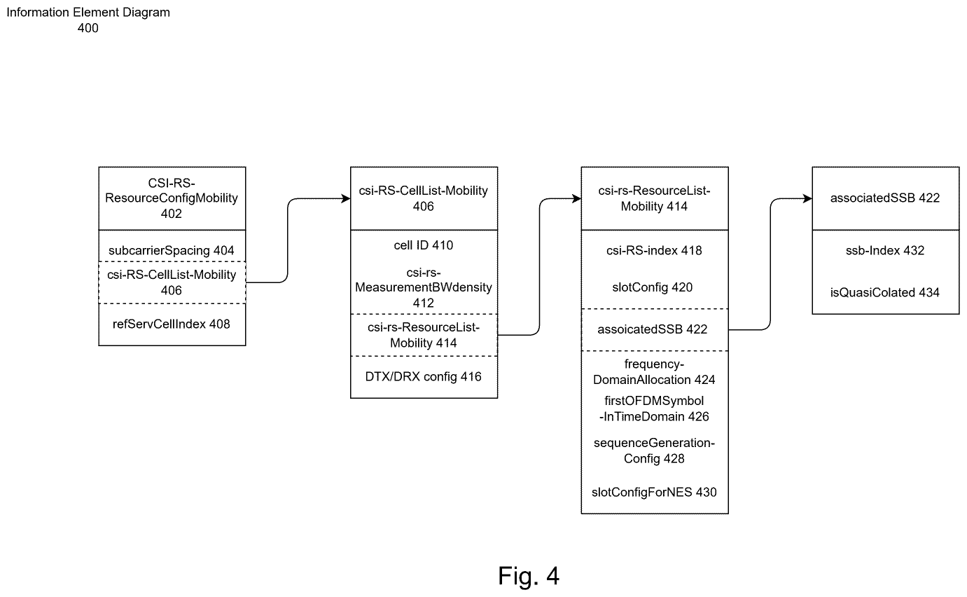

FIG. 4 shows an information element diagram 400 according to various exemplary embodiments. One of skill in the art will understands that each IEs may contain other IEs, e. g., sub-IEs. As described above, the IEs shown in the IE diagram 400 are transmitted from a serving gNB (e.g., the gNB 120A) to a UE (e.g., the UE 110) and may provide, among other things, information about neighbor cells. The IE diagram 400 shows four expanded IEs (thereby showing their sub-IEs), CSI-RS-ResourceConfigMobility 402, csi-RS-CellList-Mobility 406, csi-rs-ResourceList-Mobility 414, and associatedSSB 422. For an example of how the shown IEs are contained, the ResourceConfigMobility 402 contains the csi-RS-CellList-Mobility 406.

The CSI-RS-ResourceConfigMobility 402 is shown containing the following IEs: subcarrierSpacing 404, csi-RS-CellList-Mobility 406, and refServCellIndex 408. Of note is that the csi-RS-CellList-Mobility 406 contains CSI-RS information for mobility for a plurality of neighbor cells (e.g., gNB 120B). It should be understood that further discussion of IEs henceforth is with respect to a single neighboring cell (e.g., gNB 120B), but one of skill in the art will recognize that in scenarios with multiple neighbor cells, the csi-RS-CellList-Mobility 406 will contain information for multiple neighbor cells and not just one neighbor cell such as the gNB 120B.

In the csi-RS-CellList-Mobility 406 are IEs cellID 410, csi-rs-MeasurementBWdensity 412, csi-rs-ResourceList-Mobility 414, and DTX/DRX config 416. The DTX/DRX config 416 may also be understood to be a DTX/DRX pattern in some embodiments. The DTX/DRX config 416 may include information about the neighbor cell DTX active/inactive time window (e.g., the window duration, offset, DTX cycle information, etc.). From this it can be seen that the DTX/DRX configuration information is on a per cell basis, e.g., for each neighbor cell.

The csi-rs-ResourceList-Mobility 414 is configured on a per-resource basis. In the csi-rs-ResourceList-Mobility 414 are csi-RS-index 418, slotConfig 420, associatedSSB 422, frequencyDomainAllocation 424, firstOFDMSymbolInTimeDomain 426, and slotConfigForNES 430.

The network may configure a slot patten for NES in the form of the slotConfigforNES 430. The slotConfigforNES 430 indicates to the UE 110 the resources (e.g., frequencies) and times that the neighbor cell gNB 120B will not transmit CSI-RS because of NES. The slotConfigForNES 430 indicates the time periodicity and offset for the CSI-RS of the neighbor cell gNB 120B when the neighbor cell gNB 120B is using NES mode.

In the associatedSSB 422 are ssb-Index 432 and isQuasiColated 434. One of skill in the art will recognize that mobility operations may be Synchronization Signal Block (SSB) based or CSI-RS based. Discussion of SSB-based mobility operations of the exemplary embodiments will occur below.

In a second aspect of the exemplary embodiments, new UE measurement behavior for mobility measurements without measurement gap (MG) is disclosed herein. When a UE is performing a CSI-RS based mobility measurement on a neighbor cell without measurement gap (MG) (e.g., inter-frequency measurement), for each target neighbor cell, the UE needs to determine whether the target cell is using DTX or NES mode.

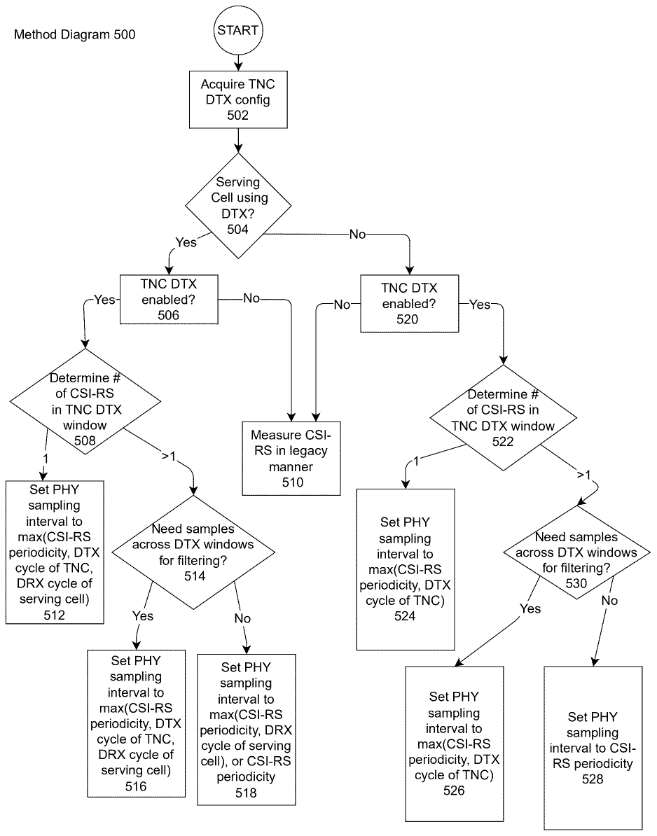

FIG. 5 shows a method diagram 500 for UE measurement behavior for mobility measurements without measurement gap (MG) according to various exemplary embodiments. The method diagram 500 is applicable to situations in which the UE 110 is performing a CSI-RS based mobility measurement on a target neighbor cell (TNC) without MG. Again, one of skill in the art will understand that reference to a single target neighbor cell is only exemplary, the UE may perform mobility measurements for any number of neighbor cells. Reference to TNC in the method diagram 500 may be understood to refer to the gNB 120B.

In 502, the UE 110 acquires a DTX configuration for the gNB 120B. Typical operations of the UE 110 with a serving cell (e.g., gNB 120A) include reports on neighboring cells. The TNC DTX configuration 502 may include a DTX window duration and offset and a DTX cycle (for example, via the DTX/DRX config 416).

In 504, the UE 110 determines whether the serving cell (e.g., the gNB 120A) is using DTX. If the serving cell is using DTX, in 506, the UE 110 determines if the DTX of the TNC is currently enabled. If the TNC does not have DTX enabled, the UE 110 proceeds to 510. In 510, the UE 110 measures CSI-RS in a legacy manner.

If the TNC does has DTX enabled, the UE 110 proceeds to 508. In 508, the UE 110 determines the number of CSI-RS in the TNC DTX window, e.g., the number of times the TNC will transmit a CSI-RS resource set in the TNC DTX window.

If the number of CSI-RS in the TNC DTX window is one, the UE 110 proceeds to 512. In 512, the UE 110 sets the physical layer (PHY) sampling interval for measuring CSI-RS from the TNC. In this example, the PHY sampling interval is determined based on max{CSI-RS periodicity, DTX cycle of neighbor cell, DRX cycle of serving cell}. As can be seen from this equation, the CSI-RS periodicity, the DTX cycle of the TNC and the DRX cycle of serving cell are taken into account when setting the PHY sampling interval. This assures that the UE 110 will receive the CSI-RS transmitted by the TNC.

Returning to method 500, if the number of CSI-RS in the TNC DTX window is greater than one in 508, the UE 110 proceeds to 514. In 514, the UE 110 determines whether samples across DTX windows will be used for filtering.

If the UE 110 uses samples across windows for filtering, the UE 110 proceeds to 516 and sets the PHY sampling interval to max{CSI-RS periodicity, DTX cycle of TNC, DRX cycle of serving cell}. Similar to the example above, the DTX cycle of the TNC and the DRX cycle of serving cell are taken into account when setting the PHY sampling interval. This assures that the UE 110 will receive the CSI-RS transmitted by the TNC in multiple DTX windows that may be used for filtering.

If the UE 110 does not use samples across DTX windows for filtering, the UE 110 proceeds from the determination 514 to 518. In 518, the UE 110 sets the PHY sampling window within the DTX window to be max{CSI-RS periodicity, DRX cycle of serving cell}, or the CSI-RS periodicity. In each of these cases, this will assure that the UE 110 will receive CSI-RS in at least one DTX window.

In some exemplary embodiments, the operations following the “yes” path from the determination 506 (508, 512, 514, 516, 518) may be replaced with the UE 110 setting the PHY sampling interval to max{CSI-RS periodicity, DTX cycle of neighbor cell, DRX cycle of serving cell}. In this example, the UE 110 will be assured of receiving CSI-RS in each of the DTX windows of the TNC where CSI-RS are transmitted.

Returning now to the determination 504, discussion will now follow the “no” path (i.e., the serving cell is not using DTX) to determination 520. In the determination 520, if the TNC does not have DTX enabled, the UE 110 measures the CSI-RS in a legacy manner in 510.

If the TNC does have DTX enabled, the UE 110 proceeds to 522, in which the UE 110 determines the number of CSI-RS in the TNC DTX window.

If the number of CSI-RS in the TNC DTX window is one, the UE 110 proceeds to 524. In 524, the UE 110 sets the physical layer (PHY) sampling interval to max{CSI-RS periodicity, DTX cycle of neighbor cell}. Since the serving cell is not using DTX/DRX (as determined in 504), this mode of operation does not need to be accounted for when setting the PHY sampling interval. Thus, only the CSI-RS periodicity and DTX cycle of the neighbor cell is used to set the PHY sampling interval.

If the number of CSI-RS in the TNC DTX window is greater than one, the UE 110 proceeds to 530. In 530, the UE 110 determines whether it will use samples across windows for filtering.

If the UE 110 uses samples across DTX windows for filtering, the UE 110 proceeds to 526. In 526, the UE 110 sets the PHY sampling interval to max{CSI-RS periodicity, DTX cycle of TNC}.

If the UE 110 does not use samples across DTX windows for filtering, the UE 110 proceeds to 528. In 528, the UE 110 sets the PHY sampling interval to the CSI-RS periodicity.

In some exemplary embodiments, the operations following the “yes” path from the determination 520 (522, 524, 530, 526, 528) may instead be replaced with the UE 110 setting the PHY sampling interval to max{CSI-RS periodicity, DTX cycle of neighbor cell}.

FIG. 5 and the method diagram 500 were described with respect to situations in which a UE is performing a CSI-RS based mobility measurement on a TNC without MG.

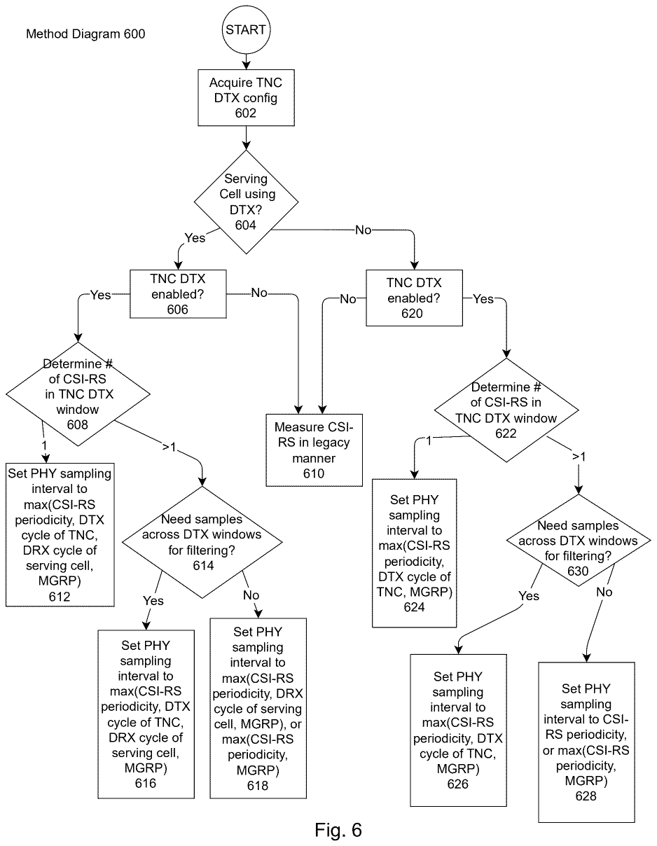

FIG. 6 shows a method diagram 600 for UE measurement behavior for mobility measurements with a measurement gap (MG) according to various exemplary embodiments. The method situations in which a UE is performing a CSI-RS based mobility measurement on a TNC with MG. The MG for CSI-RS measurement may be fully or partially overlapped with DTX windows of the TNC. When full overlaps occurs, the MG has the same or a smaller periodicity than the DTX cycle periodicity (i.e., all the MG occasions are overlapped with the DTX cycle). Partial overlap indicates that the measurement gap repetition period (MGRP) is greater than DTX cycle periodicity (i.e., part of the MG occasions are overlapped with the DTX cycle).

The operations 602, 604, 606, 608, 610, 614, 620, 622, and 630 are substantially similar to the operations 502, 504, 506, 508, 510, 514, 520, 522, and 530, respectively, described above with reference to FIG. 5 and therefore will not be described again. The difference between the method 500 and the method 600 is the variables that are considered when setting the PHY sampling interval. In the method 600, in addition to considering one or more of the DTX cycle of the TNC, the CSI-RS periodicity and the DRX cycle of serving cell, the MG also has to be taken into account (e.g., by considering the MGRP in certain scenarios).

Returning to the method 600 and proceeding from the determination 608, if the number of CSI-RS in the TNC DTX window is one, the UE 110 proceeds to 612. In 612, the UE 110 sets the physical layer (PHY) sampling interval to max {CSI-RS periodicity, DTX cycle of the TNC, DRX cycle of serving cell, MGRP}. Thus, in this scenario, the MG is considered when setting the PHY sampling interval.

If the number of CSI-RS in the TNC DTX window is greater than one, the UE 110 proceeds to 614. In 614, the UE 110 determines whether it uses samples across DTX windows for filtering.

If the UE 110 uses samples across windows for filtering, the UE 110 proceeds to 616 and sets the PHY sampling interval to max{CSI-RS periodicity, DTX cycle of TNC, DRX cycle of serving cell, MGRP}. Again, considering the MG when setting the PHY sampling interval in this scenario.

If the UE 110 does not use samples across DTX windows for filtering, the UE 110 proceeds from the determination 614 to 618, in which the UE 110 sets the PHY sampling window within the DTX window to be max{CSI-RS periodicity, DRX cycle of serving cell, MGRP}, or max{CSI-RS periodicity, MGRP}.

In some exemplary embodiments, the operations following the “yes” path from the determination 606 (608, 612, 614, 616, 618) may instead be replaced with the UE 110 setting the PHY sampling interval to max{CSI-RS periodicity, DTX cycle of neighbor cell, DRX cycle of serving cell, MGRP}.

Returning now to the determination 604, discussion will now follow the “no” path (i.e., the serving cell is not using DTX) to determination 620. In the determination 620, if the TNC does not have DTX enabled, the UE 110 measures the CSI-RS in a legacy manner in 610.

If the TNC does have DTX enabled, the UE 110 proceeds to 622, in which the UE 110 determines the number of CSI-RS in the TNC DTX window.

If the number of CSI-RS in the TNC DTX window is one, the UE 110 proceeds to 624. In 624, the UE 110 sets the physical layer (PHY) sampling interval to max{CSI-RS periodicity, DTX cycle of TNC, MGRP}.

If the number of CSI-RS in the TNC DTX window is greater than one, the UE 110 proceeds to 630. In 630, the UE 110 determines whether it uses samples across windows for filtering.

If the UE 110 uses samples across DTX windows for filtering, the UE 110 proceeds to 626. In 626, the UE 110 sets the PHY sampling interval to max{CSI-RS periodicity, DTX cycle of neighbor cell, MGRP}.

If the UE 110 does not use samples across DTX windows for filtering, the UE 110 proceeds to 628. In 628, the UE 110 Sets the PHY sampling interval to the CSI-RS periodicity, or max{CSI-RS periodicity, MGRP}.

In some exemplary embodiments, the operations following the “yes” path from the determination 620 (622, 624, 630, 626, 628) may instead be replaced with the UE 110 setting the PHY sampling interval to max{CSI-RS periodicity, DTX cycle of neighbor cell, MGRP}.

In a third aspect of the exemplary embodiments, operations related to SSB-based mobility or CSI-RS mobility are considered when the TNC is in NES mode. These operations may be performed by the network or the UE.

In a first option, the network may make the determination as to whether the UE should perform SSB-based mobility or CSI-RS mobility measurements on the TNC when the TNC has NES enabled. In this first option, the network (e.g., serving cell) may configure SSB based mobility measurements instead of CSI-RS based mobility measurements on the TNC when the TNC has NES enabled. Thus, in this option, the UE does not need to be aware of whether the TNC is in NES mode because the network will configure the UE to perform SSB based mobility measurements that should not be affected by the NES mode.

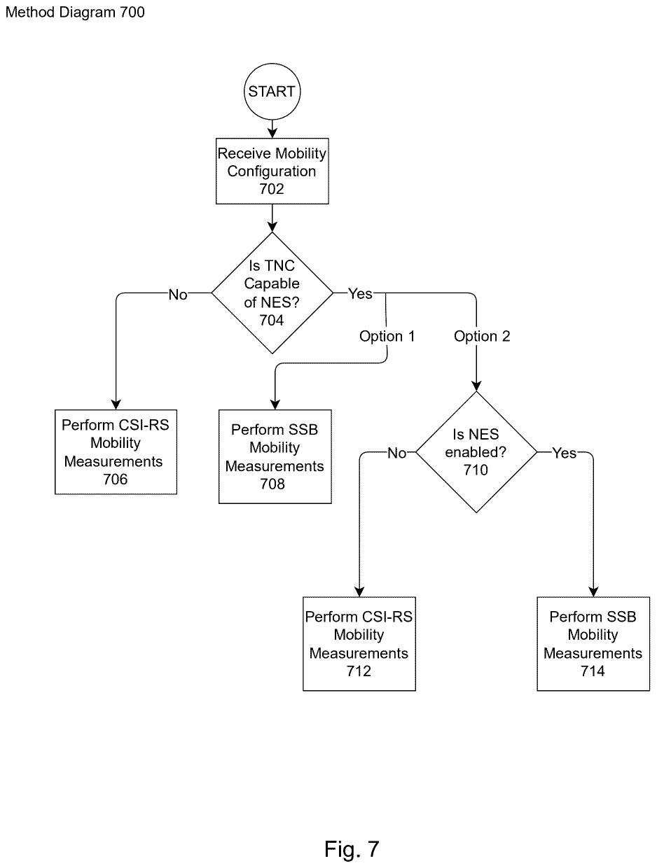

In a second option, the UE may make the determination as to whether the UE should perform SSB-based mobility or CSI-RS mobility measurements on the TNC when the TNC has NES enabled. FIG. 7 shows a method diagram 700 illustrating mobility operations when the target neighbor cell is in NES mode according to various exemplary embodiments. As stated above, in the second option the UE will make the determination as to whether to perform SSB-based mobility or CSI-RS mobility measurements on the TNC.

In 702, the UE will receive a mobility configuration from the network (e.g., serving cell) for the TNC. In this example, it may be considered that the network has configured the UE to perform CSI-RS mobility measurements on the TNC. However, as will be described in greater detail below, in some scenarios, the UE will ignore the mobility configuration (e.g., the UE will skip performing the CSI-RS mobility measurements).

In 704, the UE will determine whether the TNC is capable of operating in the NES mode. For example, if the UE receives the slotcConfigforNES 430 IE in the configuration for the TNC, the UE will understand that the TNC is capable of operating in the NES mode. However, it should be understood that there may be other manners of determining if the TNC is capable of operating in NES mode. If the TNC is not capable of operating in the NES mode, the UE will perform the CSI-RS mobility measurements as configured in the mobility configuration as shown in 706.

If, in 704, the UE determines the TNC is capable of operating in the NES mode, there may be two options for selecting the type of mobility measurements that are to be performed. The first option is shown in 708 where the UE will perform SSB mobility measurements on the TNC and skip performing the CSI-RS mobility measurements regardless of whether the TNC has enabled the NES mode.

The second option is shown in 710, 712 and 714. In this second option, the UE will first determine whether the TNC currently has the NES mode enabled. If the NES mode is not enabled, in 712, the UE will perform CSI-RS based mobility measurements on the TNC as configured in the mobility configuration. If the NES mode is enabled, in 714, the UE will perform SSB mobility measurements on the TNC and skip performing the CSI-RS mobility measurements.

### EXAMPLES

In a first example, a method performed by a user equipment (UE), comprising receiving a target neighbor cell (TNC) configuration from a network, the TNC configuration comprising a discontinuous transmission (DTX) configuration and a channel state information reference signal (CSI-RS) configuration, wherein the DTX configuration comprises a DTX cycle periodicity and wherein the CSI-RS comprises a CSI-RS periodicity, determining a physical layer (PHY) sampling interval based on at least the DTX configuration or the CSI-RS configuration and measuring CSI-RS transmitted by the TNC during the PHY sampling interval.

In a second example, the method of the first example, further comprising determining whether a serving cell is using a discontinuous reception (DRX) mode.

In a third example, the method of the second example, further comprising when the serving cell is not using the DRX mode, determining a number of CSI-RS transmitted by the TNC in a DTX window based on at least the DTX configuration and CSI-RS configuration.

In a fourth example, the method of the third example, wherein, when the number of CSI-RS transmitted by the TNC in the DTX window is one, the PHY sampling interval is determined based on a maximum of the CSI-RS periodicity or the DTX cycle periodicity.

In a fifth example, the method of the third example, wherein, when the number of CSI-RS transmitted by the TNC in the DTX window is greater than one, the method further comprises determining whether the UE is using cross DTX window samples for filtering.

In a sixth example, the method of the fifth example, wherein, when the UE is not using cross DTX window samples for filtering, the PHY sampling interval is the CSI-RS periodicity.

In a seventh example, the method of the fifth example, wherein, when the UE is using cross DTX window samples for filtering, the PHY sampling interval is determined based on a maximum of the CSI-RS periodicity or the DTX cycle periodicity.

In an eighth sixth example, the method of the third example, further comprising determining a measurement gap (MG) is used to measure the CSI-RS transmitted by the TNC, wherein the MG has a measurement gap repetition period (MGRP).

In a ninth example, the method of the eighth example, wherein when the number of CSI-RS transmitted by the TNC in the DTX window is one, the PHY sampling interval is determined based on a maximum of the CSI-RS periodicity, the DTX cycle periodicity or the MGRP.

In a tenth example, the method of the eighth example, wherein, when the number of CSI-RS transmitted by the TNC in the DTX window is greater than one, the method further comprises determining whether the UE is using cross DTX window samples for filtering.

In an eleventh example, the method of the tenth example, wherein, when the UE is not using cross DTX window samples for filtering, the PHY sampling interval is the CSI-RS periodicity or a maximum of the CSI-RS periodicity or the MGRP.

In a twelfth example, the method of the tenth example, wherein, when the UE is using cross DTX window samples for filtering, the PHY sampling interval is determined based on a maximum of the CSI-RS periodicity, the DTX cycle periodicity or the MGRP.

In a thirteenth example, the method of the second example, further comprising when the serving cell is not using the DRX mode, the PHY sampling interval is determined based on a maximum of the CSI-RS periodicity or the DTX cycle periodicity.

In a fourteenth example, the method of the second example, wherein, when the when the serving cell is not using the DRX mode, the method further comprises determining a measurement gap (MG) is used to measure the CSI-RS transmitted by the TNC, wherein the MG has a measurement gap repetition period (MGRP), wherein the PHY sampling interval is determined based on a maximum of the CSI-RS periodicity, the DTX cycle periodicity or the MGRP.

In a fifteenth example, the method of the second example, wherein, when the serving cell is using the DRX mode, the method further comprising determining a number of CSI-RS transmitted by the TNC in a DTX window based on at least the DTX configuration and CSI-RS configuration and determining a DRX cycle time for the DRX mode of the serving cell.

In a sixteenth example, the method of the fifteenth example, wherein, when the number of CSI-RS transmitted by the TNC in the DTX window is one, the PHY sampling interval is determined based on a maximum of the CSI-RS periodicity, the DTX cycle periodicity or the DRX cycle time.

In a seventeenth example, the method of the fifteenth example, wherein, when the number of CSI-RS transmitted by the TNC in the DTX window is greater than one, the method further comprises determining whether the UE is using cross DTX window samples for filtering.

In an eighteenth example, the method of the seventeenth example, wherein, when the UE is not using cross DTX window samples for filtering, the PHY sampling interval is the CSI-RS periodicity or the maximum of the CSI-RS periodicity or DRX cycle time.

In a nineteenth example, the method of the seventeenth example, wherein, when the UE is using cross DTX window samples for filtering, the PHY sampling interval is determined based on a maximum of the CSI-RS periodicity, the DTX cycle periodicity or the DRX cycle time.

In a twentieth example, the method of the fifteenth example, further comprising determining a measurement gap (MG) is used to measure the CSI-RS transmitted by the TNC, wherein the MG has a measurement gap repetition period (MGRP).

In a twenty first example, the method of the twentieth example, wherein when the number of CSI-RS transmitted by the TNC in the DTX window is one, the PHY sampling interval is determined based on a maximum of the CSI-RS periodicity, the DTX cycle periodicity, the DRX cycle time or the MGRP.

In a twenty second example, the method of the twentieth example, wherein, when the number of CSI-RS transmitted by the TNC in the DTX window is greater than one, the method further comprises determining whether the UE is using cross DTX window samples for filtering.

In a twenty third example, the method of the twenty second example, wherein, when the UE is not using cross DTX window samples for filtering, the PHY sampling interval is (a) a maximum of the CSI-RS periodicity, the DRX cycle time or the MGRP or (b) a maximum of the CSI-RS periodicity or the MGRP.

In a twenty fourth example, the method of the twenty second example, wherein, when the UE is using cross DTX window Samples for filtering, the PHY sampling interval is determined based on a maximum of the CSI-RS periodicity, the DTX cycle periodicity, the DRX cycle time or the MGRP.

In a twenty fifth example, the method of the second example, further comprising, when the serving cell is using the DRX mode, the PHY sampling interval is determined based on a maximum of the CSI-RS periodicity, the DRX cycle time or the DTX cycle periodicity.

In a twenty sixth example, the method of the second example, wherein, when the serving cell is using the DRX mode, the method further comprises determining a measurement gap (MG) is used to measure the CSI-RS transmitted by the TNC, wherein the MG has a measurement gap repetition period (MGRP), wherein the PHY sampling interval is determined based on a maximum of the CSI-RS periodicity, the DTX cycle periodicity, the DRX cycle time or the MGRP.

In a twenty seventh example, one or more processors configured to perform any of the methods of the first through twenty sixth examples.

In a twenty eighth example, a user equipment (UE) comprising a transceiver configured to communicate with a network and a processor communicatively coupled to the transceiver and configured to perform any of the methods of the first through twenty sixth examples.

In a twenty ninth example, a method performed by a serving cell, comprising determining a target neighbor cell (TNC) for a user equipment (UE) is operating in a network energy saving (NES) mode and configuring the UE to perform synchronization signal block (SSB)-based mobility measurements based on the TNC operating in the NES mode.

In a thirtieth example, one or more processors configured to perform the method of the twenty ninth example.

In a thirty first example, a base station comprising a transceiver configured to communicate with a user equipment (UE) and a processor communicatively coupled to the transceiver and configured to perform the method of the twenty ninth example.

In a thirty second example, a method performed by a user equipment (UE), comprising determining whether a target neighbor cell (TNC) for the UE is operating in a network energy saving (NES) mode and receiving a mobility configuration from a network indicating the UE is to perform channel state information reference signal (CSI-RS) mobility measurements on the TNC.

In a thirty third example, the method of the thirty second example, further comprising performing synchronization signal block (SSB)-based mobility measurements on the TNC and skipping performing CSI-RS mobility measurements on the TNC.

In a thirty fourth example, the method of the thirty second example, further comprising, when the TNC is operating in the NES mode, performing synchronization signal block (SSB)-based mobility measurements on the TNC and skipping performing CSI-RS mobility measurements on the TNC.

In a thirty fifth example, the method of the thirty second example, further comprising, when the TNC is not operating in the NES mode, performing CSI-RS mobility measurements on the TNC based on the mobility configuration.

In a thirty sixth example, one or more processors configured to perform any of the methods of the thirty second through thirty fifth examples.

In a twenty eighth example, a user equipment (UE) comprising a transceiver configured to communicate with a network and a processor communicatively coupled to the transceiver and configured to perform any of the methods of the thirty second through thirty fifth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
receiving a target neighbor cell (TNC) configuration from a network, the TNC configuration comprising a discontinuous transmission (DTX) configuration and a channel state information reference signal (CSI-RS) configuration, wherein the DTX configuration comprises a DTX cycle periodicity and wherein the CSI-RS comprises a CSI-RS periodicity;
determining a physical layer (PHY) sampling interval based on at least the DTX configuration or the CSI-RS configuration; and
measuring CSI-RS transmitted by the TNC during the PHY sampling interval.

2. The method of claim 1, further comprising:
determining whether a serving cell is using a discontinuous reception (DRX) mode.

3. The method of claim 2, further comprising:
when the serving cell is not using the DRX mode, determining a number of CSI-RS transmitted by the TNC in a DTX window based on at least the DTX configuration and CSI-RS configuration.

4. The method of claim 3, wherein, when the number of CSI-RS transmitted by the TNC in the DTX window is one, the PHY sampling interval is determined based on a maximum of the CSI-RS periodicity or the DTX cycle periodicity.

5. The method of claim 3, wherein, when the number of CSI-RS transmitted by the TNC in the DTX window is greater than one, the method further comprises:
determining whether the UE is using cross DTX window samples for filtering.

6. The method of claim 5, wherein, when the UE is not using cross DTX window samples for filtering, the PHY sampling interval is the CSI-RS periodicity.

7. The method of claim 5, wherein, when the UE is using cross DTX window samples for filtering, the PHY sampling interval is determined based on a maximum of the CSI-RS periodicity or the DTX cycle periodicity.

8. The method of claim 3, further comprising:
determining a measurement gap (MG) is used to measure the CSI-RS transmitted by the TNC, wherein the MG has a measurement gap repetition period (MGRP).

9. The method of claim 8, wherein when the number of CSI-RS transmitted by the TNC in the DTX window is one, the PHY sampling interval is determined based on a maximum of the CSI-RS periodicity, the DTX cycle periodicity or the MGRP.

10. The method of claim 8, wherein, when the number of CSI-RS transmitted by the TNC in the DTX window is greater than one, the method further comprises:
determining whether the UE is using cross DTX window samples for filtering.

11. The method of claim 10, wherein, when the UE is not using cross DTX window samples for filtering, the PHY sampling interval is the CSI-RS periodicity or a maximum of the CSI-RS periodicity or the MGRP.

12. The method of claim 10, wherein, when the UE is using cross DTX window samples for filtering, the PHY sampling interval is determined based on a maximum of the CSI-RS periodicity, the DTX cycle periodicity or the MGRP.

13. The method of claim 2, wherein, when the serving cell is using the DRX mode, the method further comprising:
determining a number of CSI-RS transmitted by the TNC in a DTX window based on at least the DTX configuration and CSI-RS configuration; and
determining a DRX cycle time for the DRX mode of the serving cell.

14. The method of claim 13, wherein, when the number of CSI-RS transmitted by the TNC in the DTX window is one, the PHY sampling interval is determined based on a maximum of the CSI-RS periodicity, the DTX cycle periodicity or the DRX cycle time.

15. The method of claim 13, wherein, when the number of CSI-RS transmitted by the TNC in the DTX window is greater than one, the method further comprises:
determining whether the UE is using cross DTX window samples for filtering.

16. The method of claim 15, wherein, when the UE is not using cross DTX window samples for filtering, the PHY sampling interval is the CSI-RS periodicity or the maximum of the CSI-RS periodicity or DRX cycle time.

17. The method of claim 15, wherein, when the UE is using cross DTX window samples for filtering, the PHY sampling interval is determined based on a maximum of the CSI-RS periodicity, the DTX cycle periodicity or the DRX cycle time.

18. The method of claim 13, further comprising:
determining a measurement gap (MG) is used to measure the CSI-RS transmitted by the TNC, wherein the MG has a measurement gap repetition period (MGRP).

19. The method of claim 18, wherein when the number of CSI-RS transmitted by the TNC in the DTX window is one, the PHY sampling interval is determined based on a maximum of the CSI-RS periodicity, the DTX cycle periodicity, the DRX cycle time or the MGRP.

20. The method of claim 18, wherein, when the number of CSI-RS transmitted by the TNC in the DTX window is greater than one, the method further comprises:
determining whether the UE is using cross DTX window samples for filtering.

21. (canceled)

22. (canceled)
